(19) United States
(12) Patent Application Publication
(10) Pub. No.: US 2001/0051046 A1
(43) Pub. Date: Dec. 13, 2001

(54) Camera

(75) Inventors: Yoji Watanabe, Tokyo (JP); Atsushi Maruyama, Sagamihara-shi (JP); Junichi Ito, Tokyo (JP)

Correspondence Address: John C. Pokotylo, STRAUB & POKOTYLO, Suite 56, 1 Bethany Road, Hazlet, NJ, 07730, US

(73) Assignee: Olympus Optical Co., Ltd.

(21) Appl. No.: 09/867,988

(22) Filed: May 30, 2001

(30) Foreign Application Priority Data
Jun. 6, 2000 (JP) 2000-169592

(51) Int. Cl. G03B 17/18; H04N 7/18

(52) U.S. Cl. 396/287; 396/446; 396/429; 396/538; 348/64

(57) ABSTRACT

A camera comprises an exposure unit to expose film to an object image and an image pick-up unit to pick up object images with an image pick-up element and output electronic picked up images, and further comprises a film pressure member to make contact with and press against the above film; a camera back cover having an aperture; a liquid crystal display panel to display the above electronic picked up images; a backlight to illuminate the display face of the above liquid crystal display panel from the back side of the above liquid crystal display panel; a light-blocking case which houses at least the above liquid crystal display panel and the above backlight, having a bottom face and side walls, and which is designed such that, when the above liquid crystal display panel is housed, the side thereof facing the display face of the liquid crystal display panel is opened; a clamping mechanism to clamp the above light-blocking case, together with the above film pressure member, to the above back cover, such that the display face of the above liquid crystal display panel is exposed from the aperture of the above back cover; and, an opaque member, positioned between the above back cover and the light-blocking case, which blocks external light from the aperture of the back cover when the light-blocking case is attached to the above back cover.

This application claims benefit of Japanese Application No. 2000-169592 filed in Japan on Jun. 6, 2000, the contents of which are incorporated by this reference.

### BACKGROUND OF THE INVENTION

1. Field of the Invention

This invention relates to a camera comprising an exposure unit to expose film to an object image, and an image pick-up unit to pick up an image of the object and to output an electronic picked up image.

2. Description of the Related Art

In recent years, numerous cameras which expose film to an object image have adopted electronic means for control of photography operation. Among this type of camera, there are also cameras which have a liquid crystal display panel to display the photography mode and photography conditions.

On the other hand, with increases in the number of pixels of solid-state image pick-up elements, recently electronic image pick-up cameras have been developed and put into use. Among such types of electronic image pick-up cameras, there are cameras comprising a liquid crystal display panel which display the electronically picked up object image immediately after image pick-up.

Cameras having both film-photography functions and electronic image pick-up functions using solid-state image pick-up elements or similar have also been developed and put into use, and technology is also known which utilizes a liquid crystal display panel for display of film-photography modes and conditions and for display of electronically picked up images.

The above liquid crystal display panels are generally positioned on the outer cover of the camera, in which is positioned the camera photographic optical system. Focusing on increased thinness of the liquid crystal display panel positioned on the outer cover, for example Japanese Laid-open patent publication No. H11-149121 discloses the camera construction described below.

In the construction of the camera according to Japanese Laid-open patent publication No. H11-149121, first, a screen frame to expose the display face of a liquid crystal display panel is provided on the outer cover. In this screen frame, the above liquid crystal display panel is positioned such that the display face is directly exposed to the outside. On the back face of this liquid crystal display panel is positioned a backlight EL sheet; on the back surface of this EL sheet is provided a film platen to press against the back surface of the film.

Thereby this means the entire liquid crystal display panel can be made thin, and the film platen provided on the back surface of the backlight EL sheet can protect the thinner liquid crystal display panel from deformation caused by external forces.

As liquid crystal display panels, reflective-type liquid crystal display devices and backlit-type liquid crystal display panels are known. In reflective-type liquid crystal display devices, by providing a reflective plate on the back surface of the liquid crystal display panel, external light incident from the liquid crystal display panel is reflected by the above reflective plate, and the reflected light causes the characters, shapes, and images (hereinafter simply “images”) formed on the above liquid crystal display panel to be displayed. In backlit-type liquid crystal display devices, a backlight is positioned on the back face of the above liquid crystal display panel, and white light from this backlight causes the images formed on the liquid crystal display panel to be displayed.

The above reflective-type liquid crystal display devices have poor image visibility in dark places with little external light, whereas the above backlit-type liquid crystal display devices have good image visibility without being influenced by external light conditions. Consequently backlit-type liquid crystal display devices are often used.

The above Japanese Laid-open patent publication No. H11-149121 discloses a camera which uses the above backlit-type liquid crystal display device for display of the photography mode or photography conditions, and for display of picked up images in electronic image pick-up. In this camera disclosed in Japanese Laid-open patent publication No. H11-149121, the backlit-type liquid crystal display device is positioned on the outer face on the rear side (back cover) of the camera.

That is, in this camera the backlit-type liquid crystal display device is positioned behind the film, so that if no countermeasures are taken, there are concerns that external light from the gap between the screen frame of the aperture exposing the display surface of the liquid crystal display device provided on the back cover and the backlit liquid crystal display device, or stray light from the backlight, may be incident on the film. Hence in the camera disclosed in this Japanese Laid-open patent publication No. H11-149121, when positioning the backlit-type liquid crystal display device on the back cover of the camera, light-blocking of the film must be performed reliably.

Consequently, the efficiency of operations when mounting the backlit-type liquid crystal display device on the camera back cover is worsened, and the construction is made more complex.

### SUMMARY OF THE INVENTION

A first object of this invention is to provide a camera enabling simple installation on the camera outer face of a backlit-type liquid crystal display device, and enabling reliable film light blocking.

A second object of this invention is to provide a camera enabling simple installation on the camera outer face of a backlit-type liquid crystal display device, and preventing incidence on the film of external light from the installation aperture between the backlit liquid crystal display device and outer face and of stray light from the backlight.

Briefly, the camera of this invention, comprising an exposure unit for exposure of film to an object image and an image pick-up unit for the image pick-up of an object by an image pick-up element and output of electronic picked up images, comprises the following:

a film pressure member, to place contact pressure on the above film; a camera back cover having an aperture; a liquid crystal display panel for display of the above electronic picked up images; a backlight to illuminate the display face of the above liquid crystal display panel from the rear side of the above liquid crystal display panel; a light-blocking case, which houses at least the above liquid crystal display panel and the above backlight, having a bottom face and side walls, and which is designed such that when the above liquid crystal display panel is housed, the side thereof facing the display-face side of the liquid crystal display panel is opened; a fastening mechanism, which fastens the above light-blocking case together with the above film pressure member to the above back cover, so as to expose the display face of the above liquid crystal display panel from the above back cover aperture; and, an opaque member, positioned between the above back cover and the light-blocking case, such that when the light-blocking case is attached to the above back cover, external light from the aperture of the back cover is shielded.

The above and other objects, features and advantages of the invention will become more apparent from the following description when taken in conjunction with the accompanying drawings.

### BRIEF DESCRIPTION OF THE DRAWINGS

FIG. 1 is a perspective view showing the disassembled backlit-type liquid crystal display device used in the camera of a first embodiment of the invention;

FIG. 2 is a block diagram showing the overall configuration of the camera of the first embodiment of the invention;

FIG. 3 is a perspective view showing the appearance of the backlit-type liquid crystal display device of the camera of the first embodiment of the invention, on incorporation into the camera; and,

FIG. 4 is a perspective view showing the appearance of the backlit-type liquid crystal display device of the camera of a second embodiment of the invention, on incorporation into the camera.

### DESCRIPTION OF THE PREFERRED EMBODIMENTS

Below, embodiments of the invention are explained with reference to the drawings.

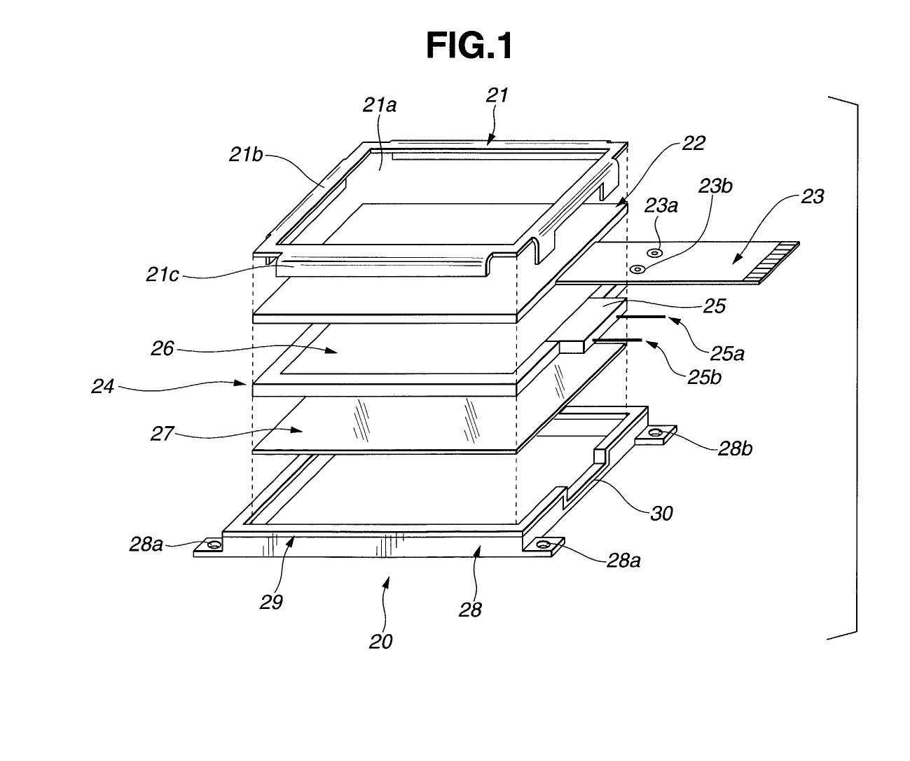

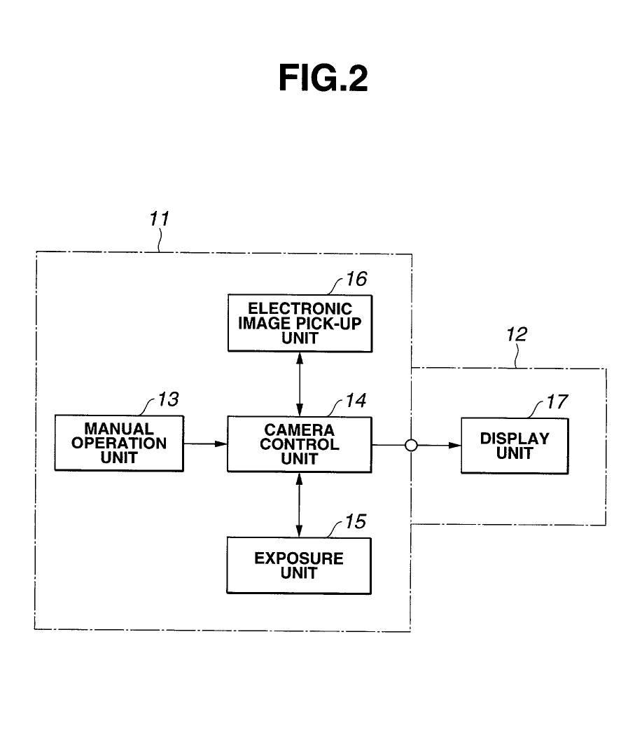

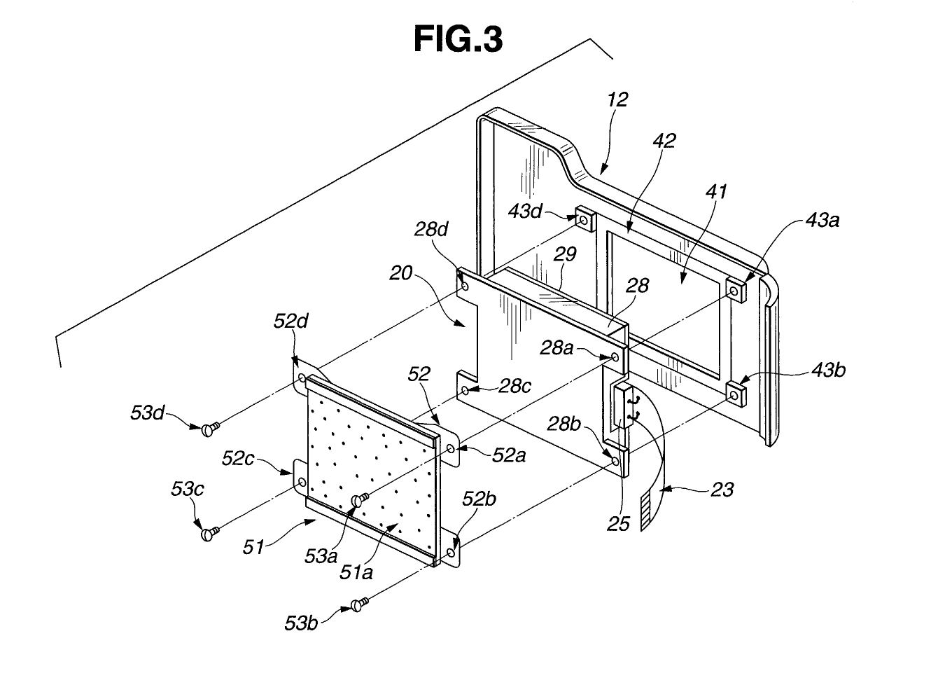

FIG. 1 is a perspective view showing the disassembled backlit-type liquid crystal display device used in the camera of a first embodiment of the invention, and FIG. 2 is a block diagram showing the overall configuration of the camera of the first embodiment of the invention. FIG. 3 is a perspective view showing the appearance of the backlit-type liquid crystal display device of the camera of the first embodiment of the invention, on incorporation into the camera.

First, FIG. 2 is used to explain the overall configuration of the camera of the first embodiment of this invention. The camera 11 has an exposure unit 15 and an electronic image pick-up unit 16. The exposure unit 15 and electronic image pick-up unit 16 operate in response to control signals from the camera control unit 14.

The above exposure unit 15 is a publicly-known camera mechanism, comprising a photographic lens, aperture mechanism, shutter mechanism, film feed mechanism and other components, not shown.

The above electronic image pick-up unit 16 is a publicly known digital still camera mechanism, comprising an image pick-up lens, solid-state image pick-up element, image processing circuitry and other components, not shown.

The above camera control unit 14 drives and controls the above exposure unit 15 and electronic image pick-up unit 16 by means of control signals, in response to manual operation from the manual operation unit 13. The above manual operation unit 13 comprises a release button, aperture setting ring, shutter adjustment member, photography mode setting switch, and other components.

The camera 11 is provided with a back cover 12, which is opened and closed when loading film into the camera 11. On this back cover 12 is positioned a display unit 17 to display electronic images picked up by the above electronic image pick-up unit 16 and to display camera control information and similar. This display unit 17 is formed from a backlit-type liquid crystal display device. This backlit-type liquid crystal display device has a liquid crystal display panel containing a liquid crystal display element, and a backlight panel containing an illumination member to illuminate the display face of the liquid crystal display panel from the back-face side.

The detailed configuration of a display unit 17 configured from such a backlit-type liquid crystal display device is explained using FIG. 1.

The backlit-type liquid crystal display device (hereafter, simply an “LCD unit” or “display unit”) 20 comprises a retaining fixture 21, LCD panel 22, backlight panel 24, reflective plate 27, light-blocking case 28 and other components.

The above retaining fixture 21 is formed from metal material, and has a rectangular-shape aperture 21a which exposes the display face of the rectangular-shape LCD panel 22; a frame 21b which presses against the edges of the LCD panel 22 and backlight panel 24; and retaining clasps 21c, formed by bending the edges of the frame 21b in the vertical direction in the figure.

The above LCD panel 22 has a plurality of pixel electrodes, not shown, positioned within the panel; a plurality of horizontal and vertical scanning electrodes connected to these pixel electrodes are provided on the perimeter of the panel, and are connected to a flexible board 23. On the flexible board 23 are formed a plurality of signal lines to supply driving and control signals to the above horizontal and vertical scanning electrodes. The base edge of this flexible board 23 is connected to an LCD panel driving circuit, not shown, and the flexible board is drawn to the outside from one edge of the LCD panel 22.

On the above flexible board 23 are provided power terminals 23a, 23b for connection with the power supply circuit which supplies backlight lighting power to the backlight panel 24, described below.

The above backlight panel 24 is positioned opposing the rear face of the above LCD panel 22. The backlight panel 24 has a white-light LED module 25 as the backlight which is the light source for illuminating light, and a light-guiding member 26 one side of which is connected to this white-light LED module 25. This light-guiding member 26 has approximately the same shape and dimensions as the above LCD panel 22.

The above light-guiding member 26 guides light emitted from the above white-light LED module 25, dispersing the light uniformly, and illuminating the LCD panel 22 with illuminating light from the rear face of the LCD panel 22.

On the above white-light LED module 25 are provided an anode terminal 25a and cathode terminal 25b to supply power for light illumination. This anode terminal 25a and cathode terminal 25b are electrically connected to the power terminals 23a, 23b respectively of the above flexible board 23.

On the rear-face side of the above backlight panel 24 is positioned a reflective plate 27, opposing the rear face of the backlight panel 24. This reflective plate 27 is provided to reflect illuminating light from the above backlight panel 24 toward the above LCD panel 22.

The light-blocking case 28 is formed from a light-blocking metal material or resin material, has a bottom face and side walls, and is open on one side such that when housing the LCD panel 22, the display face of the LCD panel 22 is exposed. In this light-blocking case 28 are stored the LCD panel 22, backlight panel 24 and reflective plate 27, inserted in order within the frame 21b of the above retaining fixture 21 to form an integrated unit. On the upper faces of the side walls of this light-blocking case 28 is attached foamy opaque sponge, opaque rubber, or other opaque material 29.

A depression 30 is formed in part of a side wall of the light-blocking case 28. This depression 30 is to draw out the flexible board 23 connected to the above LCD panel 22 and the above white-light LED module 25. The above opaque material 29 is attached to the upper face of this depression 30 also.

In the four corners of the light-blocking case 28 are formed clamping feet 28a to 28d, as clamping mechanisms to install and fix in place the light-blocking case 28 to the camera back cover. Due to the nature of the drawing, the clamping foot 28c is not shown. In each of these clamping feet 28a to 28d are provided through-holes which are penetrated by screws, described below.

Assembly of the LCD unit 20 is here explained. First, the LCD panel 22 is inserted into the inner face of the frame 21b such that the display face of the LCD panel 22 is positioned within the aperture 21a of the retaining fixture 21, and the backlight panel 24 and reflective plate 27 are inserted in order in the rear face of the LCD panel 22 to form an integrated whole. This integrated member is housed within the light-blocking case 28 such that the rear face of the above reflective plate 27 is positioned on the bottom face of the light-blocking case 28, to form the LCD unit 20.

Or, the reflective plate 27 may be first placed on the bottom face of the above light-blocking case 28, and then the backlight panel 24 and LCD panel 22 placed in order on the top face of the reflective plate 28, after which the retaining fixture 21 is used to fix in place the reflective plate 27, backlight panel 24 and LCD panel 22 within the above light-blocking case 28, to assemble the components into an integrated whole.

Installation and fixing in place on the back cover 12 of the camera 11 of the LCD unit 20 formed in this way is explained using FIG. 3. Parts which are the same in FIG. 1 or FIG. 2 are assigned the same symbols, and a detailed explanation is omitted.

On the back cover 12 is provided a seat for the above LCD unit 20; in this seat is provided an aperture 41 to expose the display face of the LCD panel 22 of the LCD unit 20. On the inside face of the back cover 12 (that is, the face which faces the camera interior), on the perimeter of the aperture 41, is attached an opaque member 42 formed from the same material as the opaque material 29 of the above light-blocking case 28. This opaque member 42 is provided in a position so as to make contact with the opaque material 29 provided on the upper face of the side walls of the above light-blocking case 28.

Nuts 43a to 43d having screw holes are provided at positions in contact with the clamping feet 28a to 28d provided on the above light-blocking case 28, near the perimeter of the aperture 41 on the inside face of the above back cover 12.

A detailed explanation is given below, but when installing the LCD unit 20 on the back cover 12, the LCD unit 20 is installed on the inner face of the back cover 12, and together with the film platen 51 described below, is screwed in place to the nuts 43a to 43d using the screws 53a to 53d. At this time the LCD unit 20 is installed such that the display face of the LCD panel 22 is exposed from the aperture 41 of the back cover 12.

As shown in FIG. 3, the film platen 51 is positioned in contact against the LCD unit 20 on the inside of the back cover 12. This film platen 51 is screwed in place to the nuts 43a to 43d using screws 53a to 53d.

This film platen 51 retains the film loaded into the camera 11 in the prescribed position, and presses against the back face of the film with prescribed pressure such that the film is planar; the film platen has a film contact face 51a which is in contact with and presses against the back face of the film. In the four corners of this film contact face 51a are provided pressure springs 52a to 52d. In these pressure springs 52a to 52d are opened through-holes; the through-holes of these pressure springs 52a to 52d are provided in positions coinciding with the through-holes of the clamping feet 28a to 28d of the above LCD unit 20 and with the screw holes provided in the nuts 43a to 43d in the above back cover 12.

When installing the above LCD unit 20 and film platen 51 on the back cover 12, as explained above, first the LCD unit 20 is positioned on the inside of the back cover 12 such that the display face of the LCD panel 22 is exposed from the above aperture 41, and the film platen 51 is placed so as to be in contact against the LCD unit 20. The LCD unit 20 and film platen 51 are then screwed in place to the nuts 43a to 43d using screws 53a to 53d. That is, the screws 53a to 53d are passed through the through-holes of the pressure springs 52a to 52d of the film platen 51 and through the through-holes of the clamping feet 28a to 28d of the above LCD unit 20, and are screwed into the nuts 43a to 43d of the back cover 12.

Thus in the camera of this first embodiment, an LCD unit 20, wherein an LCD panel 22, backlight panel 24 and reflective plate 27 are integrally incorporated into a light-blocking case 28, is installed and fixed in place in the aperture 41 from the inside of the back cover 12 by the film platen 51. An opaque material 29 and opaque member 42 are affixed to the faces in contact with the light-blocking case 28 and back cover 12, respectively, so that stray light from the above backlight panel 24 and external light from the aperture 41 of the back cover 12 can be blocked.

On installing the LCD unit 20 and film platen 51 on the back cover 12, four screws can be used for reliable fastening and assembly, so that assembly efficiency is improved.

Next, a second embodiment of this invention is explained. The camera of this second embodiment has a backlit-type liquid crystal display device differing from that of the above first embodiment.

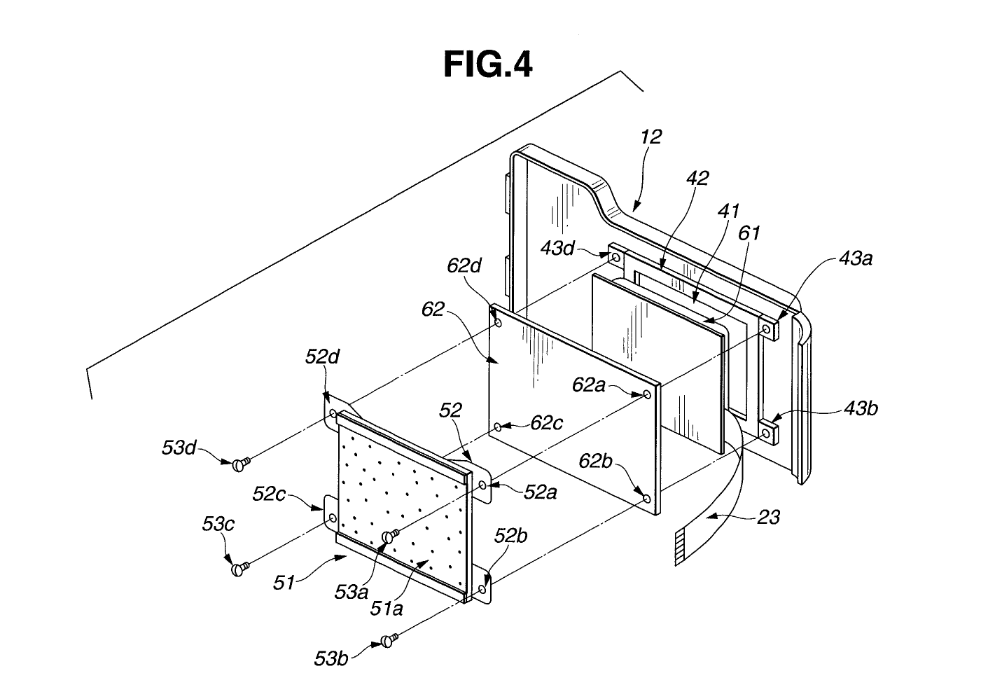

FIG. 4 is a perspective view showing the appearance when incorporating the backlit-type liquid crystal display device of the camera of the second embodiment of this invention into the camera. Parts which are similar to those of the above first embodiment are assigned the same symbols, and a detailed explanation is omitted.

The LCD unit 61 shown in FIG. 4 comprises the LCD panel 22, backlight panel 24 and reflective plate 27 of the above first embodiment, housed integrally in a metal case. Such LCD units 61 are distributed as general-purpose backlit-type liquid crystal display devices. This general-purpose LCD unit 61 is also connected to a flexible board 23, to which are connected the scanning signal supply lines of the LCD panel 22 and the power supply circuit for the light source of the backlight panel 24.

As shown in FIG. 4, a light-blocking plate 62 is positioned on the inner side of this general-purpose LCD unit 61. In the four corners of this light-blocking plate 62 are opened screw through-holes 62a to 62d.

In this second embodiment, when the above LCD unit 61, light-blocking plate 62 and film platen 51 are installed on the back cover 12, first the LCD unit 61 is positioned on the inside of the back cover 12 such that the display face is exposed from the aperture 41, and the above light-blocking plate 62 is positioned on the camera inner side of the LCD unit 61; on the camera inner side of the above light-blocking plate 62 is positioned the film platen 51. After passing the screws 53a to 53d through the through-holes of the pressure springs 52a to 52d of the film platen 51 and through the screw through-holes 62a to 62d of the light-blocking plate 62, the screws are screwed into the nuts 43a to 43d of the back cover 12.

By this means, the light-blocking plate 62 and the opaque member 42 of the back cover 12 are in contact, stray light from the backlight of the LCD unit 61 and external light from the aperture 41 are blocked, and the film is shielded from illumination. Also, the LCD unit 61 and light-blocking plate 62, and the film platen 51, are installed and fixed by four screws to the back cover 12, so that assembly efficiency is improved.

In the above embodiment of the invention, an explanation has been given using the example of a camera adopting a design in which film is loaded by opening and closing the back cover, with an LCD panel positioned on this back cover. This invention can also be applied to cameras using APS (a registered trademark) film. In this case, the above LCD panel is directly positioned on the outer face of the camera back. This is because APS film is loaded from an APS film loading hole provided on the upper face or lower face of the camera, so that there is no back cover.

That is, when this invention is applied to an APS camera, the aperture 41 in which the display face of the LCD panel 22 is positioned is provided on the back face of the above APS film camera, and the film platen 51 is used to install and fix in place the above LCD unit 20 or 61 from the inside of this aperture 41 provided in the back face. By positioning the opaque material 29 and opaque member 42 on surfaces where the above light-blocking case 28 and back face make contact, stray light from the backlight panel 24 and external light from the aperture 41 of the back face can be blocked.

As explained above, in the camera of this invention, by positioning the LCD display panel such that its display face is exposed from an aperture in the camera outer face, and by covering this LCD display panel and backlight mechanism by an opaque cover material, the incidence of external light from the aperture and stray light from the backlight mechanism can be shielded. Further, the liquid crystal display panel can be simply installed in the back cover or outer face.

Having described the preferred embodiments of the invention referring to the accompanying drawings, it is to be understood that the invention is not limited to those precise embodiments and that various changes and modifications thereof could be effected by one skilled in the art without departing from the spirit or scope of the invention as defined in the appended claims.

What is claimed is:

1. A camera, comprising an exposure unit to expose film to an object image and an image pick-up unit to pick up object images with an image pick-up element and output electronic picked up images, and further comprising:
a film pressure member to make contact with and press against the film;
a camera back cover having an aperture;
a liquid crystal display panel to display the electronic picked up images;
a backlight to illuminate the display face of the liquid crystal display panel from the back side of the liquid crystal display panel;
a light-blocking case which houses at least the liquid crystal display panel and the backlight, having a bottom face and side walls, and which is designed such that, when the liquid crystal display panel is housed, the side thereof facing the display face of the liquid crystal display panel is opened;
a clamping mechanism to clamp the light-blocking case, together with the film pressure member, to the back cover, such that the display face of the liquid crystal display panel is exposed from the aperture of the back cover; and,
an opaque member, positioned between the back cover and the light-blocking case, which blocks external light from the aperture of the back cover when the light-blocking case is attached to the back cover.

2. The camera according to claim 1, wherein is provided, on a side wall of the light-blocking case, a lead part of a flexible printed circuit board for signals of the liquid crystal display panel.

3. The camera according to claim 1, wherein a depression is formed in a side wall of the light-blocking case in order to draw out the flexible printed circuit board for signals of the liquid crystal display panel.

4. The camera according to claim 1, wherein the backlight is a white-light LED module.

5. A camera, comprising an exposure unit to expose film to an object image and an image pick-up unit to pick up object images with an image pick-up element and output electronic picked up images, and further comprising:
a film pressure member to make contact with and press against the film;
a camera back cover having an aperture;
a display unit, which is arranged between the film pressure member and the back cover such that the display face is exposed from the aperture, and which comprises an image display panel and an illumination member to illuminate the display face of the image display panel, which are housed in a light-blocking case formed from material having light-blocking properties; and,
an opaque member, positioned between the back cover and the display unit, to block external light from the aperture of the back cover.

6. The camera according to claim 5, wherein a seat to receive the light-blocking case is provided on the back cover.

7. The camera according to claim 5, wherein the display unit is fixed in place on the back cover together with the film pressure member.

8. The camera according to claim 5, wherein the image display panel and the illumination member are fixed integrally within the light-blocking case by a retaining fixture.

9. The camera according to claim 5, wherein a reflective plate is positioned on the bottom face of the display unit.

10. A camera, comprising an exposure unit to expose film to an object image and an image pick-up unit to pick up object images with an image pick-up element and output electronic picked up images, and further comprising:
a film pressure member to make contact with and press against the film;
a camera back cover having an aperture;
an image display unit to display the electronic picked up images;
a light-blocking case which houses, at least, the image display unit, having a bottom face and side walls, and which is designed such that, when the image display unit is housed, the side thereof facing the display face of the image display unit is opened;
a clamping mechanism to clamp the light-blocking case and the film pressure member integrally within the camera, such that the display face of the image display unit is exposed from the aperture of the back cover; and,
an opaque member, which blocks external light from the aperture of the back cover when the light-blocking case is attached to the back cover.
